(19) United States
(12) Patent Application Publication
(10) Pub. No.: US 2011/0031096 A1
(43) Pub. Date: Feb. 10, 2011

(54) CONTROL DEVICE FOR AN ELECTRICAL APPLIANCE

(75) Inventor: Martin Baier, Ettlingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/851,660

(22) Filed: Aug. 6, 2010

(30) Foreign Application Priority Data
Aug. 10, 2009 (DE) 10 2009 037 825.1

(51) Int. Cl. H01H 9/00

(52) U.S. Cl. 200/316

(57) ABSTRACT

A control device for an electrical appliance has as an operating unit comprising a rotary knob having an electrical display. The rotary knob is mounted on a rotary shaft connected to a switching device for rotary operation, wherein the rotary shaft comprises a material readily conducting magnetic field lines. An inductive energy supply is provided for the electrical display, wherein a secondary winding is arranged inside the rotary knob whose winding plane is passed through by the rotary shaft and the magnetic field lines of a primary winding. The primary winding is arranged behind the cover of the electrical appliance, and a winding plane of the primary winding is passed through by the rotary shaft.

### CROSS REFERENCE TO RELATED APPLICATIONS

This application claims priority to German Application Number 10 2009 037 825.1, filed on Aug. 10, 2009, the contents of which are incorporated by reference for all that it teaches.

### FIELD OF THE INVENTION

The invention relates to a control device for an electrical appliance having an operating unit designed as a rotary knob.

### BACKGROUND OF THE INVENTION

It is known from DE 10212954 A1 how to supply energy inductively through a cover of the electrical appliance to an operating unit designed as a rotary knob. A primary winding underneath the cover and a secondary winding inside the operating unit are completely separated from one another through this closed cover. However, the energy transmission is not very efficient.

### SUMMARY

An object underlying the invention is to provide a control device as mentioned at the outset, avoiding problems present in the prior art which can be eliminated, wherein an advantageous design of the control device is achieved with a simple, advantageous and efficient energy transmission.

This problem is solved in various embodiments by a control device having the features as claimed herein. Advantageous and preferred embodiments of the invention form the subject matter of the further claims and are explained in greater detail in the following. The wording of the claims is made into part of the substance of the description by express reference.

In one embodiment, a rotary shaft is connected to a switching device for rotary operation by the rotary knob. Electrical display means are arranged inside the rotary knob and can be used, for example, to show information to an operator. In accordance with one embodiment of the invention, an inductive energy supply to the display means is provided, where a secondary winding is arranged inside the rotary knob and a primary winding is arranged underneath the cover and is passed through by the rotary shaft, the latter comprising a material that readily conducts the magnetic field lines. The winding plane of the secondary winding is passed through by the rotary shaft and hence by the magnetic field lines of the primary winding. It is thus possible that a distance or transmission path between the magnetic field lines coming from the primary winding and the secondary winding inside the operating unit is very short. The efficiency of the inductive energy transmission is particularly good in particular because the magnetic field lines of the primary winding are practically transmitted by the rotary shaft, and said rotary shaft passes through the plane of the secondary winding. This above all reduces the magnetic scattering losses which might interfere with nearby electrical appliances or equipment.

In another embodiment of the invention, the primary winding itself passes through the plane of the secondary winding. To do so, it can run on or inside the rotary shaft for the rotary knob, for example, when the rotary shaft is hollow. Here too, the rotary shaft can be used to concentrate the field lines or to conduct them to the required degree. In addition, the rotary shaft acts as a holder for the primary winding.

As an alternative to this and particularly advantageously, the primary winding can be arranged on, or inside, the switching device, for example inside a switching device housing. It can have a winding plane that is substantially perpendicular to the rotary shaft, where it is passed through by the rotary shaft, and hence in turn is approximately parallel to the secondary winding inside the operating unit.

To arrange the secondary winding inside the rotary knob, it can either be inserted into it as a separate component, or alternatively it can be injection-molded. It is also possible in a further embodiment of the invention to design the secondary winding as a module, for example, in a winding housing or as a molded-around component. It can thus be fastened inside an appropriately designed recess inside the rotary knob, for example, by snapping or gluing it into place. Precise positioning and fixed arrangement are thus possible.

The display means in the rotary knob are advantageously designed as LEDs, for example, and more specifically as OLEDs. These can be individual light dots, or alternatively illuminate entire surfaces or form seven-segment displays or the like. Fluorescent lamps can also be used.

In a further embodiment of the invention, a rectifier is connected to the secondary winding inside the rotary knob. A bridge rectifier is ideal here, suitable for operating the above LEDs as display means.

Similarly, to as described above only for the secondary winding, all further components can be fastened inside the rotary knob by casting them in place or by injection-molding or molding around them. Alternatively, further parts inside the rotary knob, for example, the energy supply for the display means such as the aforementioned rectifier or even the display means themselves, can be designed as a module. They too, as described above for the secondary winding, can be fastened in appropriately designed recesses inside the rotary knob. With a modular-type design like this, it is possible to equip a control device in accordance with the invention and above all the rotary knob with different functions depending on the required scope of function. It is possible, for example, to create differently equipped variants at the same time with the same basic structure of the rotary knob and/or energy transmission.

In a similar way, parts of the energy supply for the display means containing the primary winding and arranged underneath the cover can also be designed as a module. A module of this type can then be fastened to the switching device, for example, as a known attachment part per se.

These and further features can be gathered not only from the claims, but also from the description and drawings, where the individual features, both singly or severally in the form of subcombinations, can be implemented in an embodiment of the invention and in other fields and can represent advantageous and independently protectable designs for which protection is claimed here. The subdivision of the application into individual sections and the subheadings in no way restrict the general validity of the statements made thereunder.

### BRIEF DESCRIPTION OF THE DRAWINGS

Embodiments of the invention are shown schematically in the drawings and are explained in detail in the following. The drawings show in:

FIG. 1 a lateral sectional view through a control device in accordance with one embodiment of the invention with a magnetically conducting rotary shaft magnetically linking a primary winding inside a switching device and a secondary winding inside a rotary knob for energy supply to a display inside the rotary knob;

FIG. 2 a variation of the rotary knob from FIG. 1 with a partly module-like design; and

FIG. 3 a further variation with a module-like structure of different design.

### DETAILED DESCRIPTION OF THE EMBODIMENTS

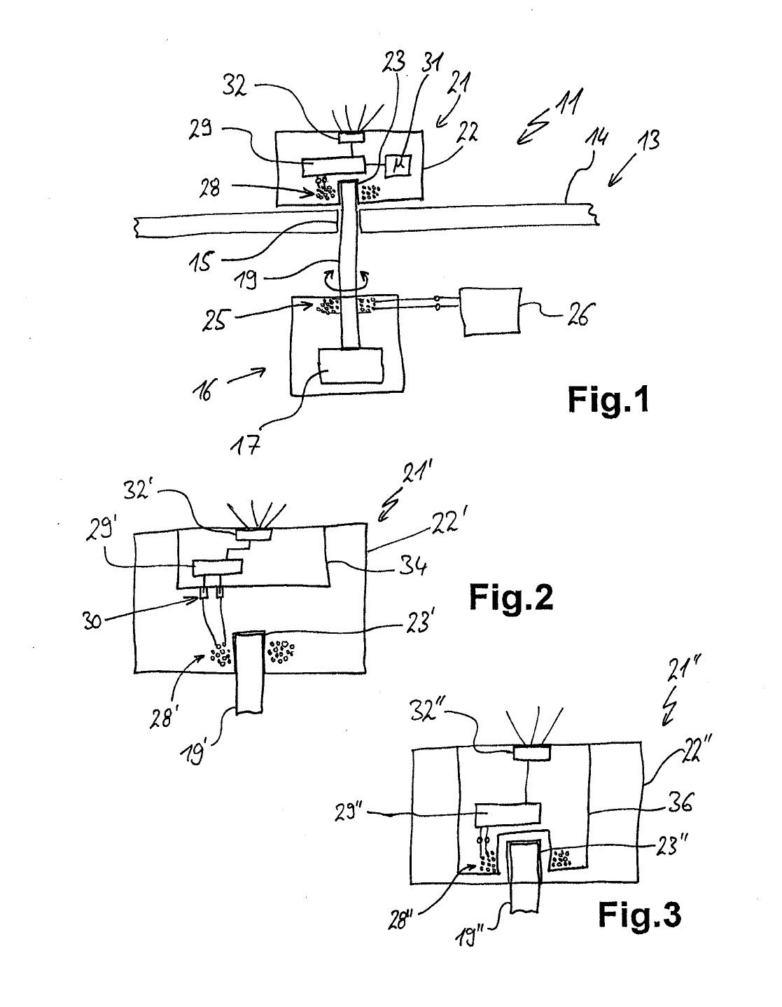

FIG. 1 shows in a schematic sectional view a control device 11 in accordance with the invention on an electrical appliance 13 with a cover 14 which can also be a so-called fascia. The cover 14 contains an opening 15.

A switching device 16 having a rotary switch 17 is arranged underneath the cover 14. This can be used, for example, to set the power of an electric function unit of the electrical appliance 13, for example of a radiant heater in the case of a glass ceramic hob. The rotary switch 17 inside the switching device 16 is operated by a rotary shaft 19 passing through the opening 15 up to just before the cover 14. There the rotary shaft 19 is inserted and fastened into a rotary knob 21 as the operating unit mentioned at the outset for the control device 11. The rotary knob 21 has a rotary knob housing 22 which has on the underside a rotary shaft receptacle 23 for insertion and fastening of the rotary shaft 19. It is thus possible to make a setting at the rotary switch 17 using the rotary knob 21. This is known from the prior art.

The upper area of the switching device 16 contains a primary winding 25 comprising a multi-winding coil, for example of thin and insulated copper wire with 10 to 100 windings. It can be designed in the known manner and be fastened inside a housing of the switching device 16. The primary winding 25 is connected to an actuating unit 26, which is dealt with in greater detail below. The magnetic field lines of the primary winding 25 are transmitted by the rotary shaft 19, which in accordance with the invention comprises a material which readily conducts magnetic field lines. A rotary shaft 19 like this can be ferritic, or alternatively comprise an appropriate iron or different iron alloys having the required properties. Furthermore, plastics with embedded magnetic or ferritic particles are generally possible, for example, iron shavings or ferrite dust. It is thus possible to ensure that the rotary shaft is not electrically conductive. This is known to the person skilled in the art and presents the latter with no problems.

The top end of the rotary shaft 19 passes through a winding plane of a secondary winding 28 provided in the lower area of the rotary knob 21. The secondary winding 28 can in principle be of similar design to the primary winding 25 and have a number of windings to match the application, for example 10 to 100.

It can thus be seen that the magnetically conducting rotary shaft 19 magnetically links the primary winding 25 to the secondary winding 28 and thereby creates a kind of transformer with the two windings 25 and 28 and a core 19. The secondary winding 28 is connected to a rectifier 29 inside the rotary knob 21, said rectifier making the energy transmitted by transformation or induction usable in a suitable form. The rectifier 29 can for example supply energy to a microcontroller 31 shown schematically, possibly even a control signal, which is inductively possible and known in principle to the person skilled in the art. Above all, however, an LED 32 or another display or light display can be supplied with energy or made to light up. Instead of, or in additional to an LED of this type, further or different types of light displays can be provided.

A bridge rectifier necessary for operation of an LED 32 can be provided inside the rectifier 29. With other light displays or lighting means or display means, it may be possible to dispense with rectification. Alternatively, and possibly more advantageously, a one-way or two-way rectifier can be provided.

Depending on the selected frequency, a filter capacitor can be provided on the rectifier 29 or be omitted. Further components may be necessary for power adjustment, which is however known to the person skilled in the art. The brightness of the LEDs 32 can be influenced by the frequency and amplitude in the primary winding 25, i.e. via the actuating unit 26.

Since the magnetically conducting rotary shaft 19 passes through the winding plane of the secondary winding 28, a particularly good magnetic linking for the transformer to the two windings 25 and 28 is possible. In this way, scattering losses are reduced, meaning not only a more efficient use of energy, but also a reduction in unwelcome magnetic field lines or effects in the vicinity of the control device 11.

Alternatively to an arrangement of the primary winding 25 inside a housing of the switching device 16, it could also be arranged in front of this housing, i.e. practically mounted on the switching device 16. In that case it may be possible to use a completely conventional switching device 16, and a surface mounting presents no problems whatsoever. It is then also possible to integrate an inverter together with electronic unit that can be controlled with DC voltage, permitting simple design.

FIG. 2 shows an alternative embodiment of a rotary knob 21′. The rotary knob housing 22′ is generally of similar design, with the secondary winding 28′ being firmly and permanently installed/injection-molded into the rotary knob 21′, which can be of plastic. An electrical connection to the secondary winding 28′ is achieved using plug contacts 30 connected to the secondary winding 28′. An inserted display module 34 is provided here that has a rectifier 29′ and an LED 32′. This display module 34 is inserted into an appropriate recess of corresponding design inside the rotary knob 21′, for example only pressed in and then engaged or glued. This insertion establishes the contact via the plug contacts 30, and hence the display module 34, in particular the rectifier 29′, is electrically connected to the secondary winding 28′. With this design for a rotary knob 21′ of a control device, it is thus possible, for example, to insert differing display modules 34 into the same rotary knob housing 22′ and/or to connect them to it. In this way, rotary knobs 21′ of simple or complicated design and with functional equipment can be manufactured.

The further variation of a rotary knob 21″ in accordance with FIG. 3 is characterized in that the rotary knob housing 22″ there contains a built-in module 36. This built-in module 36 contains a secondary winding 28″ arranged inside it, a rectifier 29″ and an LED 32″, and where necessary further parts, so that the entire functionality of the rotary knob 21″ can be contained.

As described previously for FIG. 2, the built-in module 36 is inserted into the rotary knob housing 22″ and fastened inside it. A built-in module 36 of this type has the advantage that, similarly to as described for FIG. 2, several variants can be created in simple fashion. Above all, however, any expensive arrangement or injection-molding of the secondary winding into the rotary knob housing can be dispensed with. It is also possible as a result to produce a rotary knob housing of a metal such as aluminum or special steel and then to insert a built-in module or display module substantially comprising plastic inside it.

1. A control device for an electrical appliance comprising an operating unit designed as a rotary knob and mounted on a rotary shaft passing through a cover of said electrical appliance,
wherein said rotary shaft is connected to a switching device for rotary operation using said rotary knob,
wherein electrical display means are arranged inside said rotary knob,
wherein an inductive energy supply to said display means is provided having a primary winding and a secondary winding,
wherein said secondary winding is arranged inside said rotary knob whose winding plane is passed through by said rotary shaft and magnetic field lines coming from said primary winding,
wherein said rotary shaft comprises a material for conducting field lines that readily conducts said magnetic field lines, and
wherein said primary winding is arranged behind said cover of said electrical appliance and a winding plane of said primary winding is passed through by said rotary shaft.

2. The control device according to claim 1, wherein said primary winding is arranged on a housing of said switching device.

3. The control device according to claim 1, wherein said primary winding is arranged inside a housing of said switching device.

4. The control device according to claim 1, wherein said secondary winding is positioned in said rotary knob.

5. The control device according to claim 4, wherein said secondary winding inside said rotary knob is designed as a module and fastened inside an correspondingly designed recess in said rotary knob.

6. The control device according to claim 1, wherein said secondary winding is injection-molded into said rotary knob.

7. The control device according to claim 1, wherein said display means are LEDs.

8. The control device according to claim 7, wherein a rectifier is connected to said secondary winding for operating said LEDs as display means.

9. The control device according to claim 8, wherein said rectifier is a bridge rectifier.

10. The control device according to claim 1, wherein all components are fastened inside said rotary knob by casting in place.

11. The control device according to claim 1, wherein all parts of said energy supply for said display means inside said rotary knob are designed as a module and fastened inside an correspondingly designed recess inside said rotary knob.

12. The control device according to claim 1, wherein all parts of said energy supply for said display means are designed with said primary winding underneath said cover as a module.
